(19) United States
(12) Patent Application Publication
(10) Pub. No.: US 2009/0208722 A1
(43) Pub. Date: Aug. 20, 2009

(54) Oriented Members for Thermally Conductive Interface Structures

(76) Inventors: John Francis Timmerman, Minneapolis, MN (US); Sanjay Misra, Shoreview, MN (US)

Correspondence Address: Haugen Law Firm PLLP, 1130 TCF Tower, 121 South Eighth Street, Minneapolis, MN, 55402, US

(21) Appl. No.: 12/032,759

(22) Filed: Feb. 18, 2008

(51) Int. Cl. B32B 27/00

(52) U.S. Cl. 428/221

(57) ABSTRACT

A thermally conductive interface structure for use in connection with heat-generating electronic components includes a polymer matrix material and one or more compressive members which are compressive under relatively light loads along a thickness direction of the interface structure. The compressive members are thermally conductive and define a plurality of reticulated apertures therein. The compressive members enable a relatively low compressive modulus along a thickness dimension of the thermally conductive interface structure.

### FIELD OF THE INVENTION

The present invention relates to thermally conductive interface structures generally, and more particularly to a thermally conductive interface incorporating one or more oriented thermally conductive compressive members which are compressive at least along a thickness direction of the interface structure.

### BACKGROUND OF THE INVENTION

Modern electronic devices involve a wide variety of operating electronic components mounted in close proximity with one another. Demand for increased performance and decreased size for such electronic components, has resulted in elevated levels of heat generation. For many electronic components operating efficiency is decreased at elevated temperatures, such that mechanisms are desired for heat transfer away from the electronic components. Accordingly, it is known in the art to utilize heat transfer aids such as cooling fans for moving air across the devices, cooling fluid conductor pipes, and large surface area heat sinks for removing thermal energy from in and around the respective electronic components.

A common technique for removing excess thermal energy from the heat-generating electronic components involves thermally coupling the electronic component to a relatively large surface area heat sink, which is typically made of a highly thermally conductive material, such as metal. Heat transfer away from the heat sink typically occurs at the interface between the heat sink and a cooling media such as air. In some cases, heat transfer efficiency is increased through the use of fans to direct a continuous flow of air over the heat exchanging surfaces of the heat sink.

In some instances, an interfacial material, such as a thermally conductive paste or gel, may be interposed between the heat-generating electronic component and the heat sink in order to increase heat transfer efficiency from the electronic component to the heat sink. Interfacial voids caused by uneven surfaces at the interface between the electronic component structure and the heat sink introduce thermal barriers which inhibit passage of thermal energy thereacross. The interfacial material minimizes such voids to eliminate thermal barriers and increase heat transfer efficiency.

Thermally conductive pastes or gels used in this application commonly exhibit relatively low bulk modulus, and may even be “phase changing” in that the interfacial material becomes partially liquidous and flowable at the elevated temperatures consistent with the operation of the heat-generating electronic component. Although the use of such interfacial materials has proven to be adequate for many applications, certain drawbacks nevertheless exist. For example, some of such interfacial materials may be difficult and messy to handle and install due to their low modulus/flowability characteristics. In addition, limitations have been observed on the thermal conductivity obtainable with such thermal interface materials. Given the ever-increasing demand for removal of thermal energy from electronic components, known thermal interface pastes and gels may be inadequate for certain thermal transfer applications.

In addition to the thermally conductive interfacial materials described above, other types of thermal interface structures are known in the art. For example, solid and semi-solid interface structures have been secured in place between the electronic component and the heat sink through thermally conductive adhesives and the like. While such interface structures typically exhibit high thermal conductivity values, their lack of conformability to adjacent surfaces reduces their overall thermal pathway efficiency.

Accordingly, it is a primary object of the present invention to provide a thermally conductive interface structure that is both highly thermally conductive and conformable to opposed surfaces through compressibility along at least a thickness dimension of the interface structure.

It is a further object of the present invention to provide a thermally conductive interface structure that is highly thermally conductive, compressible along the thickness direction, and may be easily handled and installed.

### SUMMARY OF THE INVENTION

By means of the present invention, thermal energy may be efficiently transported away from a heat-generating electronic component through a compact and neat arrangement. To carry out the heat transfer described above, a thermally conductive interface structure is provided which is compressible along a thickness direction parallel to the desired direction of heat transfer. The present interface structure has a relatively low compressive modulus along this thickness direction, wherein the compressive modulus is less than about 200 psi. Moreover, the interface structure is highly thermally conductive, and may have a thermal conductivity value of between about 5 and 50 W/m·K.

In a particular embodiment, the thermally conductive interface structure has a length, a width, and a thickness, and includes a matrix material and a thermally conductive compressive member which defines a respective plane extending through the thickness and the width of the interface structure. The thermally conductive compressive member includes reticulated apertures having respective axes which extend perpendicularly therethrough and which are oriented substantially along the length. The compressive member is compressible along a thickness direction.

In some embodiments, the reticulated apertures of the compressive member are substantially diamond-shaped, and define a long dimension between a first pair of opposed apices and a short dimension between a second pair of opposed apices. A length ratio between the long dimension and the short dimension may be about 2 when the compressive member is in a non-compressed condition. The apertures may make up about 40 area percent of the compressive member.

In some embodiments, the thermally conductive interface structure includes a plurality of compressive members that are disposed in substantially parallel relationship along the length. The compressive members may comprise between about 10 and about 50 volume percent of the interface structure.

In another embodiment, the thermally conductive interface structure includes a polymer matrix and a plurality of compressive members disposed along a length of the interface structure, wherein at least some of the compressive members each extend throughout a width and a thickness of the interface structure. The compressive members include strands formed into a mesh defining reticulated apertures. Moreover, the mesh is oriented such that the compressive members are compressible along a thickness direction.

In another aspect, an electronic component assembly of the invention includes a heat-generating electronic component and a thermally conductive interface structure having a length, a width, and a thickness, wherein the thickness is defined between first and second surfaces of the interface structure. At least a portion of the first surface is thermally coupled with the electronic component. The thermally conductive interface includes a polymer matrix material and one or more thermally conductive compressive members each including reticulated apertures having respective axes extending perpendicularly therethrough so as to be oriented substantially along the length. The compressive members each have a compressive bulk modulus along a thickness direction of less than about 200 psi.

A still further embodiment of the interface structure includes a polymer matrix and a thermally conductive compressive member substantially spirally wound about a first axis that is parallel to a thickness direction. The compressive member includes first and second opposed major surfaces which are oriented substantially parallel to the thickness direction and include a plurality of reticulated apertures disposed therein, the compressive member being compressible along the thickness direction.

### BRIEF DESCRIPTION OF THE DRAWINGS

FIG. 1 is a side-elevational view of an electronic component assembly of the present invention;

FIG. 2A is an isolated perspective view of an interface structure of the present invention;

FIG. 2B is a side-elevational view of an interface structure of the present invention;

FIG. 2C is a side-elevational view of an interface structure of the present invention;

FIG. 3A is an end view of an interface structure of the present invention;

FIG. 3B is an enlarged perspective view of a portion of the interface structure illustrated in FIG. 3A;

FIG. 3C is a side-elevational view of a portion of an interface structure of the present invention;

FIG. 3D is an enlarged view of a portion of an interface structure of the present invention;

FIG. 3E is an end view of an interface structure of the present invention in a compressed condition;

FIG. 4 is an enlarged view of a portion of an interface structure of the present invention;

FIG. 5 is an enlarged view of a portion of an interface structure of the present invention;

FIG. 6 is an isolation view of an interface structure of the present invention;

FIGS. 7A-7D illustrate process steps in the manufacture of an interface structure of the present invention; and

FIGS. 8A-8E illustrate process steps in the manufacture of an interface structure of the present invention.

### DETAILED DESCRIPTION OF THE PREFERRED EMBODIMENTS

The objects and advantages enumerated above together with other objects, features, and advances represented by the present invention will now be presented in terms of detailed embodiments described with reference to the attached drawing figures which are intended to be representative of various possible configurations of the invention. Other embodiments and aspects of the invention are recognized as being within the grasp of those having ordinary skill in the art.

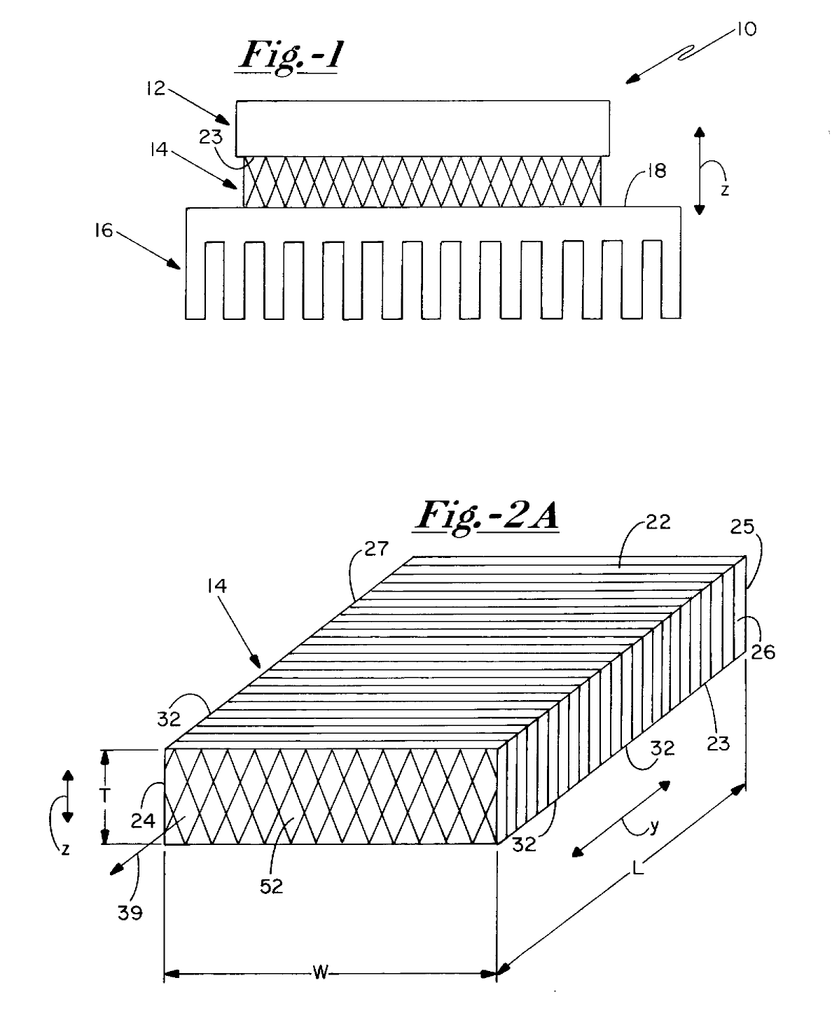

With reference now to the drawing figures, and first to FIG. 1, an electronic component assembly 10 includes a heat-generating electronic component 12, and a thermally conductive interface structure 14 which is thermally coupled to electronic component 12. In the embodiment illustrated in FIG. 1, a heat sink 16 is also included in the electronic component assembly, and is in thermal contact with thermally conductive interface structure 14 at a first surface 18 of heat sink 16. In general, the generic arrangement illustrated in FIG. 1, wherein a thermally conductive material or object is interposed between a heat-generating electronic component and a heat sink is known in the art. However, Applicants have determined that a unique thermally conductive interface structure 14 provides distinct advantages over conventional thermally conductive interface arrangements.

Heat-generating electronic component 12 is schematically illustrated in FIG. 1 as a generic device. Such component 12, however, may in practice represent a wide variety of electronic devices, such as microprocessors, integrated circuits, memory chips, hard drives, light emitting diodes, and the like. In the embodiment illustrated in FIG. 1, a first surface 23 of interface structure 14 is thermally coupled with electronic component 12, and preferably with a heat-emitting surface of electronic component 12. It is to be understood that the term “electronic component” is meant to be inclusive of all parts associated with a respective electronic device, in that interface structure 14 may be placed in thermal contact with one or more elements associated with an assembly making up electronic component 12.

In the arrangement illustrated in FIG. 1, interface structure 14 is interposed between electronic component 12 and heat sink 16. In the construction of electronic component assembly 10, interface structure 14 is sandwiched between electronic component 12 and heat sink 16, and may undergo compressive pressure along axis “z”, which may also be referred to herein as the “thickness direction”, as it is aligned along a thickness dimension of interface structure 14. As indicated above, in order to best conform to respective surfaces of electronic component 12 and heat sink 16, interface structure 14 is preferably compressible along axis “z”.

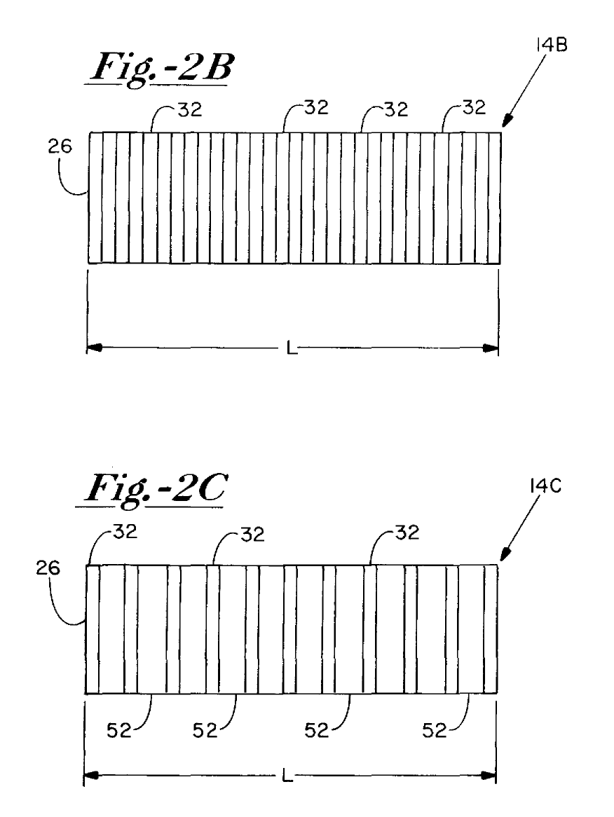

An enlarged isolation view of thermally conductive interface structure 14 is illustrated in FIG. 2, wherein interface structure 14 includes a length dimension “L”, a width dimension “W”, and a thickness dimension “T”. Interface structure 14 may be formed in a variety of shapes and sizes to meet with requirements for particular applications. In the illustrated embodiment, interface structure 14 may be substantially rectangular, wherein length dimension “L” is defined between first and second end surfaces 24, 25, width dimension “W” is defined between first and second side surfaces 26, 27, and thickness dimension “T” is defined between upper and lower surfaces 22, 23.

As further illustrated in FIG. 2A, interface structure 14 includes a plurality of compressive members disposed in substantially parallel relationship with one another along length dimension “L”. In the embodiment illustrated in FIG. 2A, compressive members 32 define respective planes which extend through width dimension “W” and through thickness dimension “T”. In some embodiments, at least some compressive members 32 themselves extend throughout thickness dimension “T” and throughout width dimension “W”. Various modifications to these arrangements may be made while retaining the scope and purposes of the invention. For example, compressive members 32 may have only a portion which extends throughout thickness dimension “T” and/or only a portion which extends throughout width dimension “W”. Conversely, compressive members 32 may themselves define a width equal to width dimension “W” and a height substantially equal to thickness dimension “T”. It is to be understood that compressive members 32 may take on a variety of shapes and sizes.

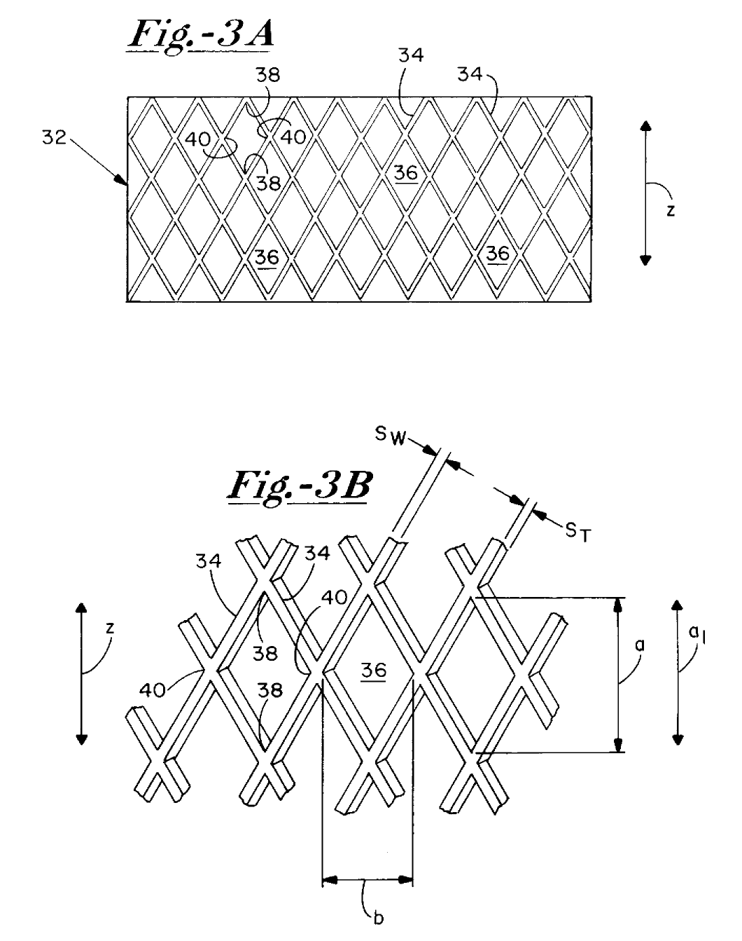

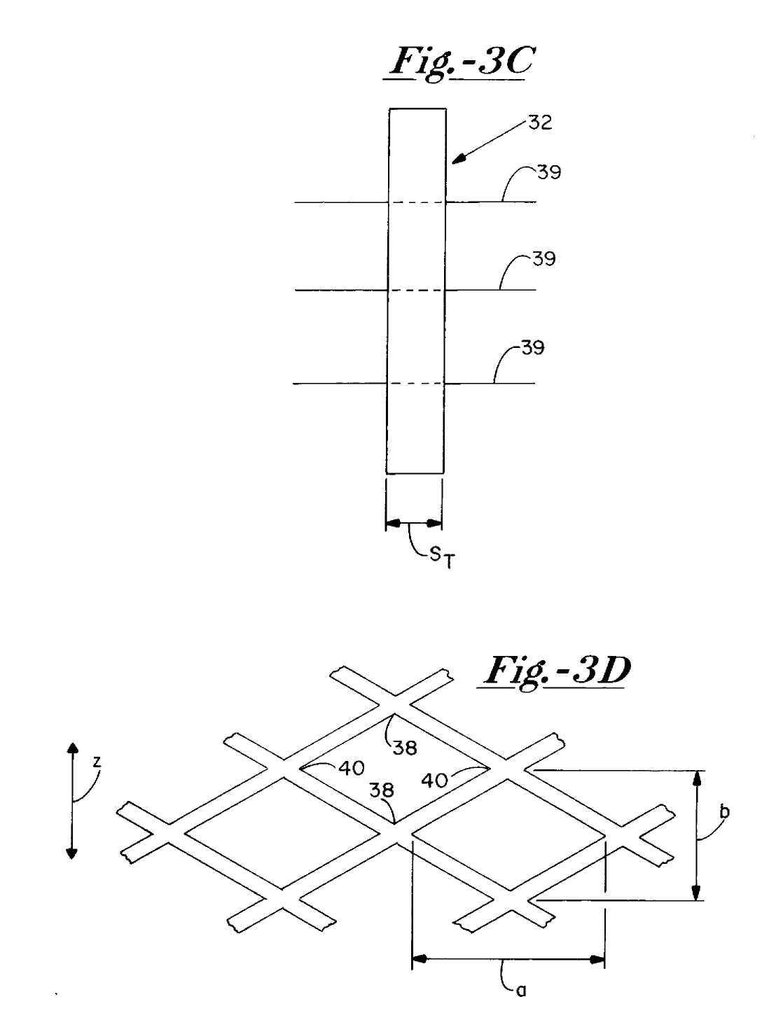

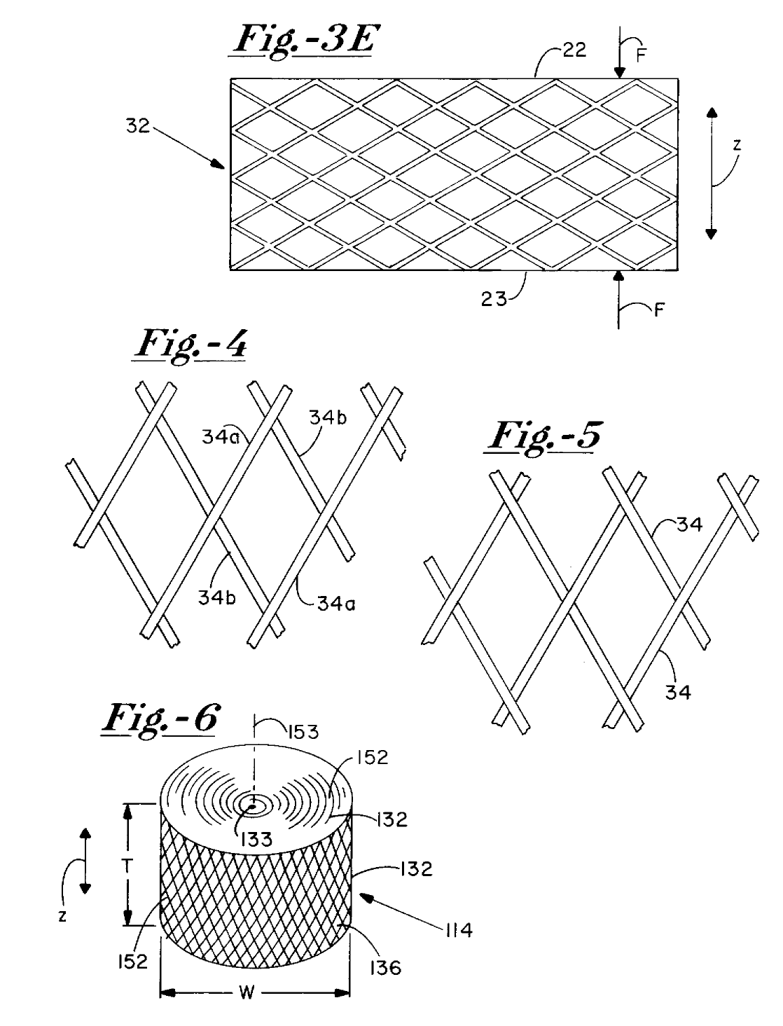

An end view of interface structure 14 in FIG. 3A illustrates compressive member 32 in an initial, non-compressed, configuration. Compressive member 32 includes strands 34 which may be patterned in woven or non-woven formats to define reticulated apertures 36 therebetween. FIG. 3B represents a non-woven strand pattern defining substantially diamond-shaped reticulated apertures 36. It is to be understood, however, that a variety of strand patterns may be employed for compressive members 32 so as to define various shapes for reticulated apertures 36. Example compressive members 32 useful in the present arrangements are available from Dexmet Corporation of Naugatuck, Conn. under the trade name MicroGrid® Precision-Expanded Foils.

In one embodiment, and as illustrated in FIGS. 2-3, the reticulated apertures defined by compressive members 32 include respective axes 39 which extend perpendicularly therethrough and which are oriented substantially along a direction parallel to a length direction “y”. In addition, reticulated apertures 36 may be substantially diamond-shaped, each having a first and second pair of opposed apices 38-38, 40-40. In one embodiment of compressive member 32, reticulated apertures 36 define a long dimension “a” between first pair of opposed apices 38-38, and a short dimension “b” between a second pair of opposed apices 40-40. In this embodiment, the length ratio between long dimension “a” and short dimension “b” is between about 1.5 and about 4 and may preferably be about 2. Long dimension “a” is illustrated in FIG. 3B as extending between first pair of opposed apices 38-38, such that a first axis “a₁” along long dimension “a” is substantially parallel to thickness direction “z”, while short dimension “b” is substantially perpendicular to thickness direction “z”. In another embodiment, as illustrated in FIG. 3D, long dimension “a” is substantially perpendicular to thickness direction “z”, while short dimension “b” is substantially parallel to thickness direction “z”.

An important aspect of the present invention is in the compressibility of compressive members 32 at least along a thickness direction “z”. To that end, strands 34 of compressive members 32 are preferably fabricated of materials and dimensions capable of deformation under relatively light loads. In particular, it is desirable to provide interface structure 14 with a compressive bulk modulus along thickness direction “z” of between about 10 and 200 psi. This range of modulus values may also be pertinent to compressive members 32 themselves, as the compressive members 32 may represent the stiffest elements in interface structure 14. As a consequence, compressive members 32, as operably oriented, may have a compressive modulus along thickness direction “z” of no more than about 200 psi.

In some embodiments, compressive members 32 may be fabricated from a ductile metal or other deformable material. Compressive members 32 may be thermally conductive such that materials selected for use in the manufacture of compressive members 32 have thermal conductivities of at least about 5 W/m·K. As such, materials such as metals, metal-coated fabric, carbon fibers, and the like are example materials useful in the construction of compressive members 32. Particular example materials for compressive members 32 include copper, aluminum, nickel, and titanium.

Compressive members 32 may utilize a variety of cross-sectional configurations for strands 34, including, for example, square, rectangular, round, oblong, and the like. Dimensions for strands 34 may be divided into strand widths “S_{w}” and strand thickness “Sₜ”. In some embodiments, strand width may between about 1 and about 10 mils, while strand thickness may be between about 2 and about 15 mils. Such size ranges render between about 1,500 and about 11,000 apertures 36 per square inch of compressive members 32. It has been found that such dimensions, along with the aperture dimensions described above, yield an overall open area in the compressive members 32 of about 40 area percent, and which provide a desired degree of compressibility along thickness direction “z”. It is to be understood, however, that other dimensions for strand width “S_{w}”, strand thickness “Sₜ”, and apertures 36 may be useful in compressive members 32, while retaining desired levels of compressibility along thickness direction “z”.

Strands 34 of compressive members 32 may refer to (i) the mesh structure of compressive members 32 as a whole, (ii) portions of an integral mesh structure such as that shown in FIGS. 3A-3D, (iii) portions of a non-woven “laminated” mesh structure as illustrated in FIG. 4, (iv) portions of a woven mesh structure as illustrated in FIG. 5, and (v) fibers or fiber bundles used in weaving a woven structure such as that illustrated in FIG. 5. Generally, strands 34 refer to the structure or structures defining reticulated apertures 36 therebetween.

FIGS. 4 and 5 represent alternative mesh constructions for compressive members 32. In particular, a “grafted” or “laminated” non-woven design for strands 34 is illustrated in FIG. 4. In such design, one set of strands 34a are secured to a second set of strands 34b through a bonding technique such as welding. Although first set strands 34a are illustrated as each being disposed on a first side of second set of strands 34b, it is contemplated that the non-woven “laminated” approach may involve other arrangements, such as alternating strands 34a being alternately disposed at opposed sides of second set of strands 34b and vice versa. Another arrangement for strands 34 of compressive members 32 is shown in FIG. 5, wherein strands 34 are woven into the mesh arrangement. In all woven and non-woven designs, compressive members 32 may be thermally conductive, at least along a thickness direction “z”. In some embodiments, it is desired that compressive members 32 are highly thermally conductive, and serve to transport most of the excess thermal energy from electronic component 12 to heat sink 16 generally along thickness direction “z”.

FIG. 3E represents an end view of interface structure 14 subsequent to compressive forces “F” being placed upon upper and lower surfaces 22, 23 thereof, such as that which occurs in the construction of electronic component assembly 10. Compressive forces “F” represent the application of force involved in the installation of heat sink 16 to lower surface 23, and of electronic component 12 to upper surface 22. The effect of such compressive forces “F” upon compressive members 32 is illustrated in comparison between FIGS. 3A and 3E. As demonstrated through such comparison, compressive members 32 are compressed along thickness direction “z” so that long dimension “a” of reticulated apertures 36 is reduced. In some cases, reduction of long dimension “a” through compressive forces “F” correspondingly increases short dimension “b” of reticulated apertures 36. In such cases, width dimension “W” of interface structure 14 may also be increased as a result of compressive forces “F” placed upon interface structure 14, as illustrated in FIG. 3E.

In addition to compressive members 32, interface structure 14 may further include a material for bonding compressive members to one another and/or securing compressive members 32 substantially in place at interface structure 14. Alternatively, such material may simply be incorporated into interface structure as a medium to fill gaps in interface structure 14. In some embodiments, such material may be thermally conductive in order to aid in the transfer of thermal energy through interface structure 14 at least along thickness direction “z”. The material may also exhibit a relatively low modulus, such as below about 20-30 psi, so as to maintain a relatively low compressive modulus for interface structure 14, at least along thickness direction “z”. Such material is referred to herein as a “matrix” which is intended to be broadly construed as any material, compound, mixture, emulsion, or the like, within which one or more compressive members may be embedded, and/or which may itself be impregnated into voids defined by and between the compressive members of the interface structure. No specific meaning for the term “matrix”, therefore, is intended herein.

In some embodiments, the matrix material may be a polymer having a relatively low compressive bulk modulus, such as below 20-30 psi. Example polymer materials useful in the matrix material of the present invention include, but are not limited to, silicones, polyurethanes, polyisobutylenes, as well as copolymers of silicone with epoxies, acrylics, or polyurethanes. It is desired that the matrix material be relatively stable at operating temperatures of electronic component assembly 10, including temperatures up to about 150-200° C. For the purposes of this application, the term “stable” is intended to mean substantially form-stable, wherein viscosity of the matrix material changes by less than about 10% between room temperature and the operating temperatures of electronic component assembly 10. More importantly, however, the matrix material does not cause the overall compressive bulk modulus of the interface structure at least along thickness direction “z” to exceed a predetermined maximum value, such as about 350 psi.

In some embodiments, the matrix material may be filled with thermally conductive and/or viscosity-modifying particulate fillers. Such particulate filler may be a ceramic material such as alumina, aluminum nitride, aluminum hydroxide, boron nitride, silica, and the like, as well as other inorganic materials and metals. Most typically, the particulate fillers are present at a loading concentration of between about 50 and 90% by weight, and have a particulate size distribution with a mean particle size of about 30-50 microns. Most typically, such particulate filler materials are included in the matrix material to enhance the thermal conductivity thereof. Thermally conductive filled polymer materials are well understood in the art as an interfacial media in heat transfer applications.

The matrix material is identified in FIGS. 2A-2C by reference numeral 52. As shown in the side view of FIGS. 2B and 2C, various embodiments for the arrangement of compressive members 32 are contemplated by the present invention. In particular, interface structure 14B includes a plurality of compressive members 32 disposed in substantially adjacent parallel relationship with one another. By contrast, compressive members 32 of interface structure 14C are disposed in parallel relationship with one another, but are adjacently spaced-apart along length dimension “L”. In the embodiment illustrated in FIG. 2C, matrix material, such as polymer matrix 52, fills the voids between respective compressive members 32. Polymer matrix 52 may also be disposed between compressive members 32 in interface structure 14B, though the voids between respective compressive members 32 may be significantly smaller than that of interface structure 14C. It is further contemplated by the present invention that the spacing between respective compressive members 32 may not be equal within a single interface structure, and may instead have various spacing as needed per application. For some embodiments, compressive members 32 take up between about 10 and about 50 volume percent of interface structure 14. In such embodiments, matrix material 52 assumes substantially the balance of the volume of interface structure 14, by being present within reticulated apertures 36, and/or between adjacent or spaced-apart compressive members 32.

A further example embodiment of an interface structure of the present invention is illustrated in FIG. 6, wherein interface structure 114 may be substantially cylindrical having a diametrical width dimension “W” and a thickness dimension “T”. In the embodiment illustrated in FIG. 6, compressive member 132 is a continuous member that is spiral wound about a central axis 133. Compressive member 132 may otherwise be similar to compressive members 32 described above, wherein compressive member 132 includes a plurality of reticulated apertures 136 such that compressive member 132 is compressible at least along a thickness direction “z”. It is further to be understood that compressive member 132 may be similar in materials, strand design and dimension, reticulated aperture configuration and dimensions, and other aspects as that described with reference to compressive members 32.

Interface structure 114 may also be similar to interface structure 14, in that polymer matrix 152 may be impregnated therein, such that polymer matrix 152 is disposed within reticulated apertures 136, and possibly between respective portions of compressive member 132.

Non-polygonal configurations for interface structure 114 other than that illustrated in FIG. 6 are also contemplated as being useful in the present invention. Moreover, any polygonal or non-polygonal interface structure may utilize a plurality of compressive members, such as compressive members 32, or may instead utilize a single compressive member, such as compressive member 132. In the cylindrical arrangement of interface structure 114, for example, a plurality of concentric members may be utilized in place of, or in addition to, continuous spiral compressive member 132. Moreover, continuous compressive members may be utilized in polygonal interface structure configurations. For example, a continuous compressive member may be wound about increasing perimeter boundaries to form a polygonal structure configuration. It is to be understood, therefore, that a wide variety of interface structure shapes may be generated through the use of one or more compressive members. Such one or more compressive members may be placed in parallel, non-parallel, spiral, or other relative orientations in the formation of the interface structures of the present invention.

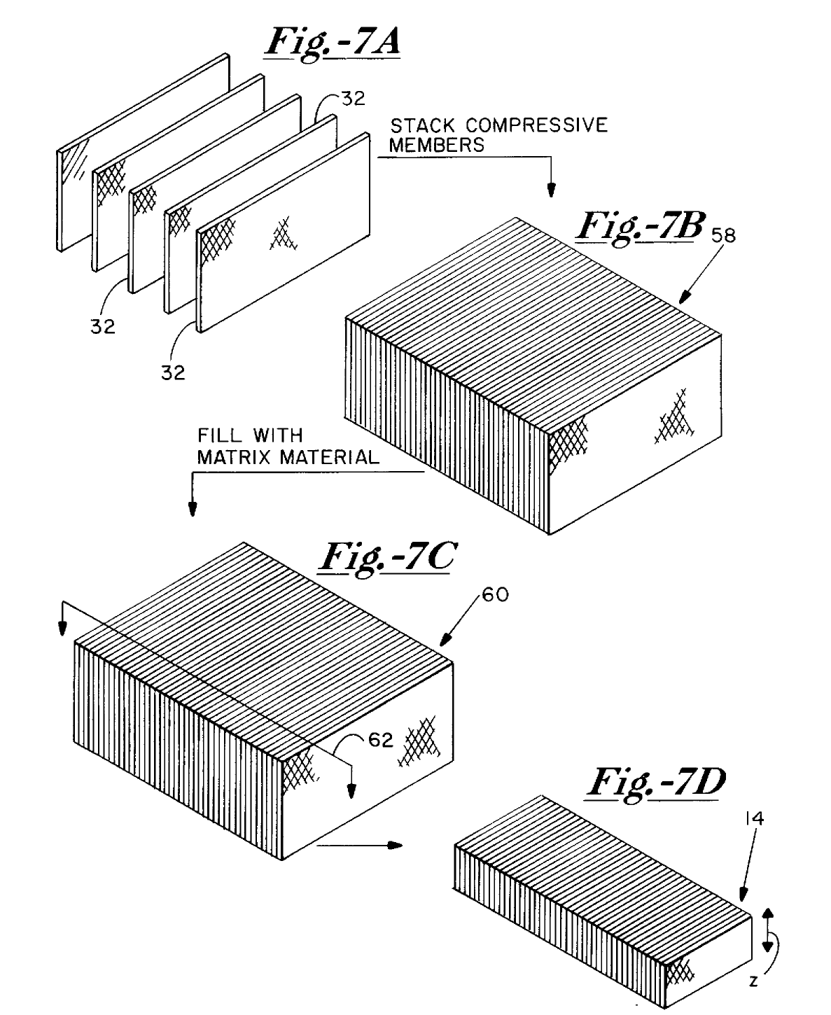

Although a variety of techniques for manufacturing the interface structures of the present invention are contemplated herein, the following sets forth example methods for making the interface structures. A construction technique of interface structure 14 is illustrated in FIGS. 7A-7D, wherein a plurality of compressive members 32 are arranged together to create a block 58 of stacked compressive members 32. Each compressive member 32 may be arranged such that strands 34 are substantially aligned in a plane parallel to thickness direction “z”. At least some of the open voids of block 58 are then filled or impregnated with matrix material 52 so as to form a filled block 60 that is between about 10 and about 50 volume percent compressive members 32, balance matrix material 52. Filled block 60 is then cut along cut-line 62 to form individual interface structures 14.

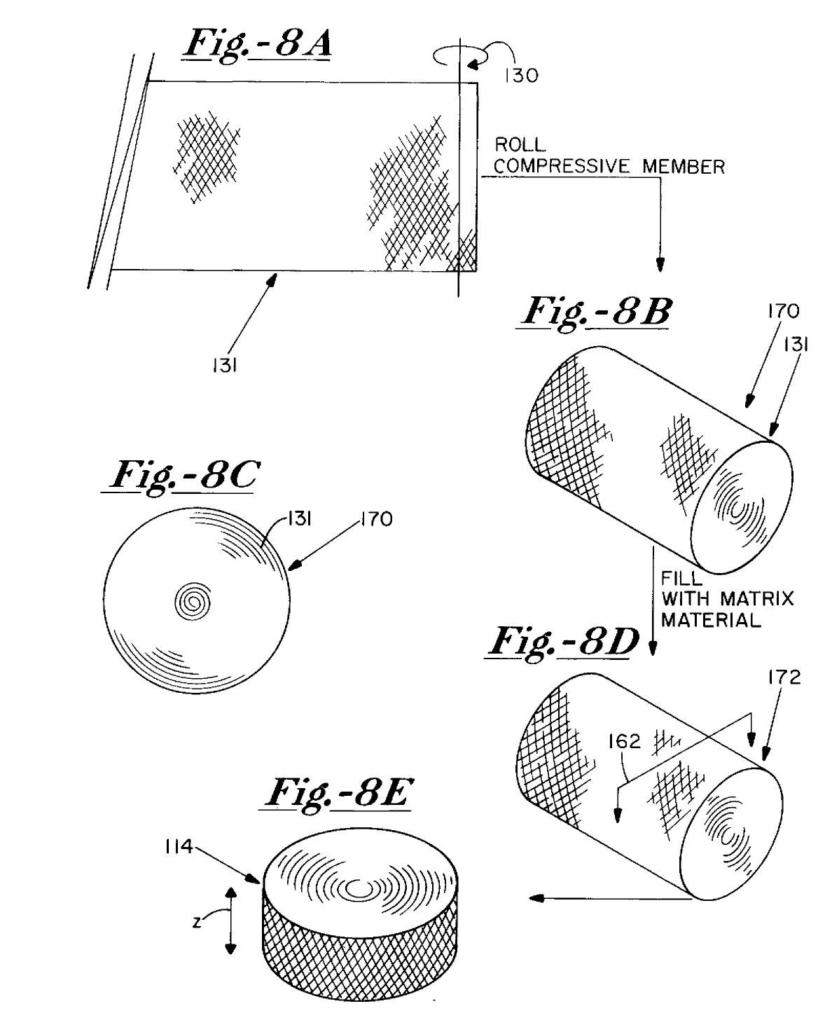

In somewhat similar fashion, interface structure 114 may be constructed through the technique illustrated in FIGS. 8A-8E, wherein a compressive member sheet 131 is rolled as depicted by direction arrow 130 into a spiral-wound tube 170, as shown in FIG. 8B. An end view of tube 170 is illustrated in FIG. 8C. Tube 170 is then filled or impregnated with matrix material 152 to form a filled tube 172, as shown in FIG. 8D. Portions of filled tube 172 are then cut along cut-line 162 to form interface structure 114, as shown in FIG. 8E. In both the techniques described with reference to FIGS. 7A-7D and 8A-8E, the matrix material may be impregnated into the interface structure by various techniques such as, for example, vacuum impregnation, pressurized matrix injection, or capillary action.

### EXAMPLES

The following sets forth example arrangements for interface structures of the present invention. The following examples, however, are intended to be exemplary only, and not restrictive as to the arrangements and materials useful in the present invention.

### Example 1

A thermally conductive interface structure having a thickness dimension of between about 100 and about 200 mil was prepared with a plurality of aluminum compressive members. The compressive members included a strand width of 5 mil and a strand thickness of 1.5 mil, which non-woven strands defined regular, reticulated, diamond-shaped apertures having a ratio of long dimension to short dimension of about 2. The long dimension of the reticulated apertures was aligned parallel to the thickness direction, and the compressive members defined an open area percent of about 38.

A vinyl terminated polydimethyl siloxane polymer with a viscosity at 25° C. of about 100 cP was mixed with a hydride crosslinker of similar viscosity in an approximately 10:1 ratio along with a 1% platinum catalyst in a 1000:1 ratio. Once cured, the neat polymer had a compressive modulus of about 20 psi at a maximum operating temperature of about 200° C. The uncured composition was impregnated into the mesh arrangement by vacuum impregnation and allowed to cure for 24 hours at 25° C. Once cured, the compressive members were present at about 35 volume percent of the overall structure.

This interface structure exhibited a compressive modulus along the thickness direction of about 75 psi and a thermal conductivity of 22 W/m·K.

### Example 2

A thermally conductive interface structure having a thickness dimension of between about 100 and about 200 mil was prepared with a plurality of aluminum compressive members. The compressive members included a strand width of 5 mil and a strand thickness of 1.5 mil, which non-woven strands defined regular, reticulated, diamond-shaped apertures having a ratio of long dimension to short dimension of about 2. The short dimension of the reticulated apertures was aligned parallel to the thickness direction, and the compressive members defined an open area percent of about 38.

Vinyl siloxane polymer as in Example 1 was impregnated into the mesh arrangement and cured such that the compressive members were present at about 35 volume percent of the overall structure.

This interface structure exhibited a compressive modulus along the thickness direction of about 50 psi and a thermal conductivity of 16 W/m·K.

### Example 3

A thermally conductive interface structure having a thickness dimension of between about 50 and about 200 mil was prepared with a wound aluminum compressive member. The compressive member included a strand width of 5 mil and a strand thickness of 1.5 mil, which non-woven strands defined regular, reticulated, diamond-shaped apertures having a ratio of long dimension to short dimension of about 2. The long dimension of the reticulated apertures was aligned parallel to the thickness direction, and the compressive member defined an open area percent of about 38.

Vinyl siloxane polymer as in Example 1 was impregnated into the mesh arrangement and cured such that the compressive member was present at about 15 volume percent of the overall structure.

This interface structure exhibited a compressive modulus along the thickness direction of about 150 psi and a thermal conductivity of 13 W/m·K.

### Example 4

A thermally conductive interface structure having a thickness dimension of between about 100 and about 200 mil was prepared with a plurality of copper compressive members. The compressive members included a strand width of 5 mil and a strand thickness of 1.5 mil, which non-woven strands defined regular, reticulated, diamond-shaped apertures having a ratio of long dimension to short dimension of about 2. The long dimension of the reticulated apertures was aligned parallel to the thickness direction, and the compressive members defined an open area percent of about 38.

Vinyl siloxane polymer as in Example 1 was impregnated into the mesh arrangement and cured such that the compressive members were present at about 20 volume percent of the overall structure.

This interface structure exhibited a compressive modulus along the thickness direction of about 130 psi and a thermal conductivity of 26 W/m·K.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different devices and that various modifications can be accomplished without departing from the scope of the invention itself.

What is claimed is:

1. A thermally conductive interface structure having a length, a width, and a thickness, said thermally conductive interface structure comprising:
(a) a matrix material; and
(b) a thermally conductive compressive member defining a respective plane extending through said thickness and said width, and including reticulated apertures having respective axes extending perpendicularly therethrough so as to be oriented substantially along said length, wherein said compressive member is compressible along a thickness direction.

2. A thermally conductive interface structure as in claim 1 having a thermal conductivity of between about 5 and about 50 W/m·K.

3. A thermally conductive interface structure as in claim 1 wherein said compressive member extends throughout said thickness.

4. A thermally conductive interface structure as in claim 1 having a compressive modulus along said thickness direction of between about 10 and about 200 psi.

5. A thermally conductive interface structure as in claim 1 wherein said compressive member comprises strands formed into a mesh.

6. A thermally conductive interface structure as in claim 1 wherein said reticulated apertures are substantially diamond-shaped.

7. A thermally conductive interface structure as in claim 6 wherein the diamond-shaped apertures define a long dimension between a first pair of opposed apices and a short dimension between a second pair of opposed apices, with a length ratio between said long dimension and said short dimension being about 2 when said compressive member is in a non-compressed condition.

8. A thermally conductive interface structure as in claim 7 wherein a first axis along said long dimension is parallel to said length direction.

9. A thermally conductive interface structure as in claim 7 wherein a first axis along said long dimension is substantially perpendicular to said length direction.

10. A thermally conductive interface structure as in claim 1 wherein said apertures comprise about 40 area percent of said compressive member.

11. A thermally conductive interface structure as in claim 1, including a plurality of said compressive members disposed in substantially parallel relationship along said length.

12. A thermally conductive interface structure as in claim 11 wherein said compressive members comprise between about 10 and about 50 volume percent of said interface structure.

13. A thermally conductive interface structure as in claim 1 wherein said matrix material includes thermally conductive particulate.

14. A thermally conductive interface structure as in claim 1 wherein said matrix material is disposed between said compressive members and within said reticulated apertures.

15. A thermally conductive interface structure having a length, a width, and a thickness, said thermally conductive interface structure comprising
(a) a polymer matrix; and
(b) a plurality of compressive members disposed along said length, at least some of said compressive members each extending throughout said width and said thickness, said compressive members comprising strands formed into a mesh defining reticulated apertures, the mesh being oriented such that said compressive members are compressible along a thickness direction.

16. A thermally conductive interface structure as in claim 15 wherein said reticulated apertures are substantially diamond-shaped and have respective axes extending substantially perpendicularly therethrough and which are oriented substantially along said length, said apertures defining a long dimension between a first pair of opposed apices, and a short dimension between a second pair of opposed apices, with a length ratio between said long dimension and said short dimension being about 2.

17. An electronic component assembly, comprising:
(a) a heat-generating electronic component; and
(b) a thermally conductive interface structure having a length, a width, and a thickness, with said thickness being defined between first and second surfaces of said interface structure, at least a portion of said first surface being thermally coupled with said electronic component, said thermally conductive interface including:
(i) a polymer matrix material; and
(ii) one or more thermally conductive compressive members including reticulated apertures having respective axes extending perpendicularly therethrough so as to be oriented substantially along said length, wherein said one or more compressive members each have a compressive bulk modulus along a thickness direction of less than about 200 psi.

18. An electronic component assembly as in claim 17, including a heat sink thermally coupled to said second surface of said interface structure.

19. An electronic component assembly as in claim 17 wherein said one or more compressive members comprise strands formed into a mesh.

20. An electronic component assembly as in claim 17 wherein said reticulated apertures are substantially diamond-shaped.

21. An electronic component assembly as in claim 17 wherein said thermally conductive compressive members have a thermal conductivity of at least about 5 W/m·K.

22. An electronic component assembly as in claim 17 wherein said polymer matrix material is disposed within said reticulated apertures.

23. A thermally conductive interface structure having a thickness defined along a thickness direction, said interface structure comprising:
(a) a polymer matrix; and
(b) a thermally conductive compressive member substantially spirally wound about a first axis that is parallel to said thickness direction, said compressive member having first and second opposed major surfaces which are oriented substantially parallel to said thickness direction and include a plurality of reticulated apertures disposed therein, said compressive member being compressible along said thickness direction.

24. A thermally conductive interface structure as in claim 23 wherein said compressive member has a compressive modulus along said thickness direction of less than about 200 psi.

25. A thermally conductive interface structure as in claim 23 wherein said polymer matrix is disposed within said reticulated apertures.
